(19) United States
(12) Patent Application Publication
(10) Pub. No.: US 2006/0190376 A1
(43) Pub. Date: Aug. 24, 2006

(54) Charged-off accounts receivable lease program

(76) Inventors: Laurence Mollner, Glencoe, IL (US); Irwin Bernstein, Highland Park, IL (US)

Correspondence Address: MCANDREWS HELD & MALLOY, LTD, 500 WEST MADISON STREET, SUITE 3400, CHICAGO, IL, 60661, US

(21) Appl. No.: 11/356,766

(22) Filed: Feb. 17, 2006

Related U.S. Application Data
(60) Provisional application No. 60/655,110, filed on Feb. 22, 2005.

(51) Int. Cl. G06Q 40/00

(52) U.S. Cl. 705/35

(57) ABSTRACT

Certain embodiments of the present invention provide Credit Grantors with an alternative to warehousing or the selling of aged accounts receivables. Certain embodiments of the present invention provide Creditors immediate cash for their accounts receivables placed on lease, shifts the cost, liabilities and collection efforts to a third party and still allows the Creditor to maintain ownership and oversight over the collection process. Certain embodiments of the present invention provide a non-recourse lease that may eliminate financial responsibility on the part of the Creditor. Certain embodiments of the present invention provide a residual payment back to the creditor that may allow the Creditor to share in the collection proceeds. Certain embodiments of the present invention provide monthly reporting to keep the Creditor informed as to collection results and to allow collection data to be used in analysis of the Creditor's credit policies, as well as other data mining jobs.

### BACKGROUND OF THE INVENTION

The present invention relates generally to management of aged accounts receivable. More specifically, the present invention relates to a charged-off accounts receivable lease program.

Current Accounts Receivable Management Programs typically start with some type of internal collection process, namely letters and phone calls to the debtor. After non-payment over a designated period of time, collection efforts are intensified either through internal collection efforts or the process is outsourced to a contingency collection agency. Corporate policy or regulatory statutes will dictate at what point in time an account receivable will be “charged-off” (written down to zero on the Balance Sheet and expensed on the Income Statement). This does not stop the collection process. Accounts are either continued to be worked internally or outsourced to contingency collection agencies. Because collection efforts go stale, accounts are generally rotated on a predetermined regular basis. Six, nine and twelve month intervals are norms. Aged accounts receivables lose their potential for collection and are either warehoused (account files stored and not worked) or sold to debt-buyers.

Warehoused accounts hold little likelihood of having the debtor paying on the account. Some funds will be paid by debtors. However, the debtors who want to clean up their past debts will be forced to seek out who and where to pay. Thus, the collection rates on warehoused accounts are very low. Additionally, warehousing requires the additional burden of file maintenance, data security and the associated expenses.

An alternative to warehousing the accounts is outsourcing the accounts to various collection agencies. Outsourced accounts will be worked by the assigned contingency agency firm who will charge a fee ranging from 20-50% and sometimes higher for collecting on the account. Collections will generally be higher on fresher debt (less time from charge-off) than on older debt. Creditors must manage the outsource process. That is, Creditors must select, monitor and audit the collection agency and maintain and move files, all of which has an associated cost. An advantage to outsourcing is the Creditor is able to dictate the type and intensity of the collection effort. This is important as many credit grantors want to continue to have or regain the client relationship. Public relations are a key in this process.

Another alternative to warehousing the accounts is to sell the accounts to a debt-buyer. While sales of charged-off debt continue to grow, many creditors find that the sales price may be less than the true value of the sold portfolio. They can no longer share in the collection process. They also lose control of the collection process and its associated information and therefore may suffer from adverse public relations as well as a loss of the data regarding the collection results.

There are many problems associated with current accounts receivable management programs. Warehousing means no collection effort is being made. Warehoused bad debt is not collected, and therefore, the asset (charged-off debt) is underutilized.

Outright sales bring in a single dollar amount (sales price), but the Creditor no longer has control and/or say in the collection process. Although a sale brings in some revenue (sales price), the lack of control over the collection process means the Creditor may suffer from adverse publicity and potential liability from overzealous collectors.

Several variations to normal sales contracts have been developed that have been called leases. However, in each of these cases, the sales contracts transfer ownership of the accounts during the so-called lease period, and all collection efforts are made in the name of the buyer. Additionally, in some of these variations, the sales price has been paid over time in several installments, as opposed to one lump sum payment. Other so-called “leases” have been structured as a sale with a guaranteed future buyback.

As previously described, warehousing means that an asset, although charged-off, is basically a non-earning asset. Although sales provide a one-time revenue pop for the original Creditor, sales also carry with them a risk that the buyer will use collection methods that are harmful to the original Creditor. Contract variations that attempt to disguise a sale as a lease do little to resolve the disadvantages associated with sales. Installment payments may extend the benefit period for the buyer and may provide a pricing advantage to the seller. However, warehousing and sales provide only small, if any, benefits to Creditors.

Thus, there is a need for an improved system and method for the management of aged accounts receivable. More particularly, there is a need for an improved charged-off accounts receivable lease program.

### BRIEF SUMMARY OF THE INVENTION

Certain embodiments of the present invention may provide Creditors with “Charged-Off” Accounts Receivables an alternative to warehousing, outsourcing, or selling their accounts.

Certain embodiments of the present invention may provide immediate cash to the Creditor with an agreed upon residual split payment. The residual feature means that the Creditor will participate in revenues above the agreed upon targeted investor return rate for the lessee.

Certain embodiments of the present invention may provide the Creditor a say in, and potentially oversight over, what collection agencies, processes and techniques can be employed during the terms of the lease. This feature eliminates the Creditor's concern about its brand image, eliminates adverse public relations and controls liability risk.

Certain embodiments of the present invention may provide a transfer of cash flow rights rather than a transfer of ownership rights. Ownership of the accounts or collection rights does not transfer from the original credit grantor. Collection efforts are made in the name of the creditor and the creditor benefits by receiving full documentation as to the work effort and results. Identifying accounts for: Payments in Full, Settlements in Full, Skips (unable to locate), Deceased, Bankrupt, Cease and Desist, Fraud, etc. enhances the creditor's asset and helps them to make better business credit decisions going forward.

Certain embodiments of the present invention may provide a non-recourse lease. The lessee assumes the risk of under-performance and improper collection efforts during the leased collection period. That is, the lease is a no-recourse lease and the lessee provides full indemnification to the creditor for its collection actions.

Certain embodiments of the present invention may provide additional features unique to the Health Care Industry. The agreed to collection process will contain predetermined settlement limits depending on need for those who will qualify for such classifications as Charity, Discounts and No-Interest Payment Terms. Additionally, under recent IRS rulings, the need to file a 1099c would be eliminated.

### BRIEF DESCRIPTION OF SEVERAL VIEWS OF THE DRAWINGS

FIG. 1 is a flow chart of a charged-off accounts receivable lease program according to an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

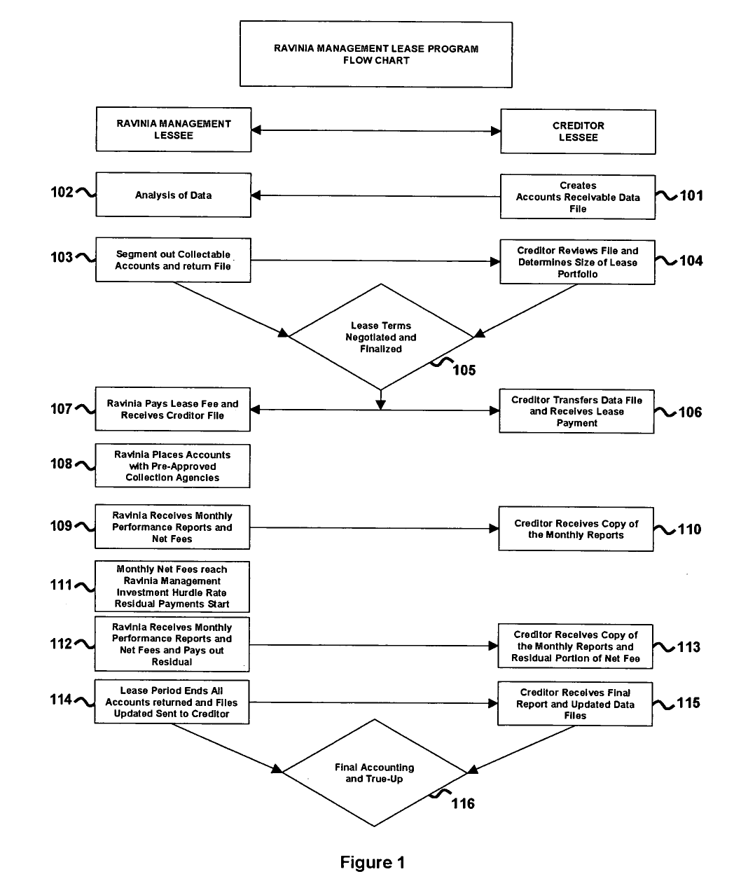

FIG. 1 illustrates a flow chart of a charged-off accounts receivable lease program[LEM1] 100 according to an embodiment of the present invention. An example of a charged-off accounts receivable lease program 100 is the Ravinia Management Lease Program (RMLP). The RMLP provides a unique alternative to the process of collecting on aged Accounts Receivables for a wide variety of Credit Grantors. Although the charged-off accounts receivable lease program 100 is described with respect to the RMLP, and more particularly, with respect to Ravinia Management and a Creditor, many different types of individuals or organizations may participate in the lease program 100 as appreciated by one of ordinary skill in the art. The steps of the lease program 100 or RMLP are as follows.

At step 101, the Creditor reviews its files of aged accounts receivables and puts them in a single file format including any and all available Client Data. The file may include, but is not limited to the file headings as listed below.

Count
Customer Account Num
Agency Level
Original Creditor
Borrower Last Name
Borrower First Name
Borrower Address 1
Borrower Address 2
City
State
Zip code
Home Phone #
Work Phone #
Cell Phone #
SSN #
DOB
Co-Borrower Name
Co-City
Co-State
Co-Zip code
Co-Home Phone #
Co-Work Phone #
Co-Cell #
Co-SSN #
Origination Date
Original Balance (if applicable)
Original Term (if applicable)
Credit Line
Credit Score
Home Equity Line
Unpaid Principal Balance
Accrued Interest & Fees
P&I Payment (if applicable)
Interest Rate
Maturity Date (if applicable)
Remaining Term (mths, if applicable)
Paid Thru Date (if applicable)
Last Payment Date
Last Payment Amount
Charge-Off Date (if applicable)
Occurrence Date (if applicable)
Charged-Off Amt (if applicable)
Third Party Servicing (mths serviced)
Auto Make
Auto Model
Auto Vin #
Repo Date
Date of Sale/Auction
Sale $ Amount
Auto Vin #
Miscellaneous
Service Provider
Account Type
Plan Type
Lender
Check Number
Checking Account #
Routing #
Check Date
Guarantor Name
College Name
Guarantee Date
Left School Date
First Payment Date
Provider Name
Service Code
Admit Date
Discharge Date

At step 102, Ravinia Management, or other individual or organization acting as a third party lessee, reviews the file with various collection agencies. Together, Ravinia Management and the collection agencies scrub the accounts to remove as many bankruptcies, deceased, cease and desist, and fraud claims as possible. With the remaining balance, Ravinia Management and the various collection agencies stratify, segment and score the accounts to determine an estimated liquidation schedule and arrive at an estimated value.

At step 103, Ravinia Management then prepares Data Files of those accounts that qualify for the lease program 100 and sends it to the Creditor. The Data Files may include one or more files and one or more accounts.

At step 104, the Creditor reviews the Data Files and determines which accounts are appropriate for placement in the lease program.

At step 105, Ravinia Management, or another third party lessee, and the Creditor negotiate lease terms, such as the initial lease payment, the length of lease, the investment hurdle rate, the residual split, the collection agencies, and the collection practices.

At step 106, the Creditor transfers the Data Files to Ravinia Management and receives a lump sum lease payment.

At step 107, Ravinia Management makes lease payment to the Creditor and receives the Data Files. At step 108, Ravinia Management starts the collection process through the pre-approved collection agencies

At step 109, Ravinia Management, or another third party lessee, receives Monthly Performance Reports from the collection agencies along with it's portion of the net collections. Ravinia Management forwards the report to the Creditor. At step 110, the Creditor receives the Monthly Performance Reports from Ravinia Management.

At step 111, the monthly reporting process of steps 109-110 is repeated until the lease investment hurdle rate is reached.

At step 112, after the hurdle rate is reached, Ravinia Management continues to receive Monthly Performance Reports from the collection agencies and its net fees. Ravinia Management forwards the Reports, and also the residual portion of the net fees, to the Creditor. At step 113, the Creditor receives the Monthly Performance Reports and its residual portion of the net fees from Ravinia Management.

At step 114, the Lease Period ends and Ravinia Management recalls all of the accounts from the collection agencies, except for any payment plans and “hot” contacts. Ravinia Management also updates the Data Files with any gathered information, such as payments, settlements, addresses, phone numbers, and notes, and returns the Data Files to the Creditor with a final Monthly Performance Report. Ravinia Management may combine the updated Data Files into a single Data File before transfer to the Creditor. At step 115, the Creditor receives the final Monthly Performance Report, residual payment and the updated Data File or Files from Ravinia Management.

At step 116, Ravinia Management and the Creditor meet to perform final accounting and true-up, which insures that all data, accounts and monies are accurate. Work may be extended due to payment plans and “hot” contracts but the formal phase of the lease agreement is concluded.

Certain embodiments of the present invention may omit one or more of these steps and/or perform the steps in a different order than the order listed. For example, some steps may not be performed in certain embodiments of the present invention. As a further example, certain steps may be performed in a different temporal order than listed above, including simultaneously.

Steps 101-104 of the lease program 100 may be similar to the steps of a sales program. As mentioned above, a sale is final and results in a onetime receipt of funds and loss of control of the ongoing collection process.

However, at step 105, lease terms are negotiated to include an upfront lease payment (immediate cash), length of lease after which responsibility for collections is returned to the Creditor, Ravinia Management's investment hurdle rate (IRR) and a residual split (the percent of all ongoing net back fee payments that the Creditor is entitled to). The Creditor is also given a say in choice of collection agencies and the extent of the collection process that may be applied during the lease period. Thus, the Creditor will have an oversight role for purposes of maintaining their public image.

Additionally, at steps 110, 113, and 114, the Creditor receives Monthly Performance Reports as to the collection process. In a straight sale of accounts, the Creditor no longer has the ability to receive collection information once the accounts are sold, whereas the RMLP assures continued receipt of collection information.

Certain embodiments of the present invention provide that the lease is a non-recourse lease. After the upfront payment is made, the Creditor will not have any responsibility to repay to Ravinia Management or its agent any shortfalls that may arise in the collection process over the terms of the lease.

Certain embodiments of the present invention provide that much of the legal liabilities associated with the collection process shifts from the Creditor to the collection agencies.

Certain embodiments of the present invention provide a unique advantage associated with a charged-off Health Care receivable. When the forgiveness of debt exceeds $600, debt-buyers who accept settlement agreements with debtors are required to issue a 1099c to the debtor and report the forgiveness to the IRS as income to the debtor. Debt forgiveness by or on behalf of a Health Care provider is not subject to the 1099c requirement. This distinction allows patients to negotiate settlements of their medical bills without becoming a recipient of 1099c “phantom income.” Using the lease, rather than a sale, to obtain money for accounts receivables will allow the medical providers to avoid a potentially devastating public relations nightmare and will allow medical providers to continue offering appropriate discounting and charity settlements without creating an undue hardship on its patients.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A charged-off accounts receivable lease program comprising:
negotiating a non-recourse lease between a creditor and a third party to transfer cash flow rights from net fees from said creditor to said third party;
reporting of collection information by said third party to said creditor; and
paying a residual portion of said net fees by said third party to said creditor.
